(19) United States
(12) Patent Application Publication
(10) Pub. No.: US 2018/0342800 A1
(43) Pub. Date: Nov. 29, 2018

(54) ELECTRONIC DEVICE

(71) Applicant: KYOCERA Corporation, Kyoto (JP)

(72) Inventor: Naoki NISHIZAKA, Sagamihara-shi (JP)

(73) Assignee: KYOCERA Corporation, Kyoto (JP)

(21) Appl. No.: 15/978,789

(22) Filed: May 14, 2018

(30) Foreign Application Priority Data
May 23, 2017 (JP) 2017-102085

(51) Int. Cl. H01Q 1/52

(52) U.S. Cl. CPC H01Q 1/525

(57) ABSTRACT

In order to further improve the communication quality, the electronic device (10) according to this disclosure includes a transmitting antenna (11), a receiving antenna (12) and a controller (14) configured to shift a receiving frequency band of the receiving antenna (12) to separate from a transmitting frequency band of the transmitting antenna (11).

### CROSS-REFERENCE TO RELATED APPLICATION

This application claims priority of Japanese Patent Application No. 2017-102085 filed in Japan on May 23, 2017, the entire disclosure of which is incorporated into this application for reference.

### TECHNICAL FIELD

This disclosure relates to an electronic device that includes a plurality of antennas.

### BACKGROUND

In recent years, there has been a growing number of antennas mounted on an electronic device such as a smartphone, a mobile phone and a tablet terminal to correspond to a plurality of communication systems such as Long Term Evolution (LTE), Wideband Code Division Multiple Access (WCDMA) and Global System for Mobile communications (GSM) or to Multiple-Input and Multiple-Output (MIMO) configured to receive signals by a plurality of antennas.

### SUMMARY

### (Solution to Problem)

An electronic device according to an aspect of this disclosure includes a transmitting antenna, a receiving antenna and a controller configured to shift a receiving frequency band of the receiving antenna to separate from a transmitting frequency band of the transmitting antenna.

### BRIEF DESCRIPTION OF THE DRAWINGS

In the accompanying drawings:

FIG. 1 illustrates an example of a configuration of a main part of an electronic device according to an embodiment of this disclosure;

FIG. 2 illustrates another example of a configuration of a main part of the electronic device according to the embodiment of this disclosure;

FIG. 3 illustrates an example of a configuration for shifting a receiving frequency band of a receiving antenna;

FIG. 4 illustrates another example of a configuration for shifting a receiving frequency band of a receiving antenna;

FIG. 5 illustrates an example of operation of the electronic device according to the embodiment of this disclosure; and

FIG. 6 illustrates another example of operation of the electronic device according to the embodiment of this disclosure.

### DETAILED DESCRIPTION

Embodiments of this disclosure are described below with reference to the drawings. It should be noted that the same reference signs in each drawing indicate the same or similar components.

In the aforementioned electronic device that includes a plurality of antennas, further improvement of the communication quality is desired.

Accounting for these considerations, it would be helpful to provide an electronic device that can further improve the communication quality.

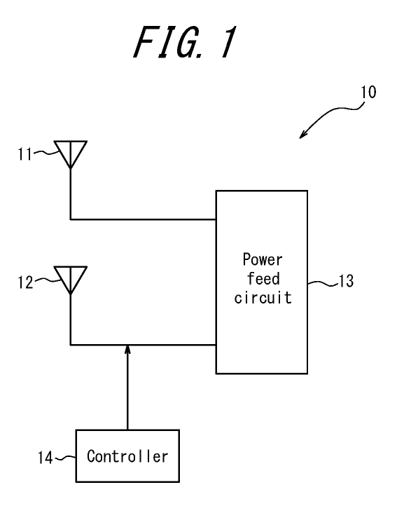

FIG. 1 illustrates an example of a configuration of a main part of an electronic device 10 according to an embodiment of this disclosure. The electronic device 10 according to this embodiment is an electronic device such as a smartphone, a mobile phone, a tablet terminal, a vehicle mounted communication device and Internet of Things (IoT), and communicates wirelessly with the other communication device (e.g. a base station) not shown. FIG. 1 illustrates only antennas configured to communicate wirelessly with other communication devices and a configuration related thereto in the electronic device 10, and a configuration to achieve various functions of the electronic device 10 is omitted.

As aforementioned, in general, a large number of antennas are required to be mounted on an electronic device to correspond to a plurality of communication bands of different communication systems and to correspond to MIMO. When a large number of antennas are mounted on a limited space in a housing of the electronic device, the distance between antennas is narrowed, and communication characteristics may degrade due to interaction (interference) between antennas. In this embodiment, a solution is provided to the aforementioned problem and degradation of communication characteristics due to interaction between antennas is suppressed to improve the communication quality.

The electronic device 10 illustrated in FIG. 1 includes a transmitting antenna 11, a receiving antenna 12, a power feed circuit 13 and a controller 14.

The transmitting antenna 11 is an antenna used for transmitting signals to other communication devices and receiving signals transmitted from other communication devices. Although the transmitting antenna 11 is used for transmitting and receiving signals, hereinafter, for convenience of explanation, it is described as used for transmitting signals.

The receiving antenna 12 is an antenna used for receiving signals transmitted from other communication devices.

The power feed circuit 13 feeds power to the transmitting antenna 11 and the receiving antenna 12.

The controller 14 shifts the receiving frequency band, which is a frequency band in which the receiving antenna 12 receives signals, to separate from the transmitting frequency band, which is a frequency band in which the transmitting antenna 11 transmits signals. The controller 14 is a processor such as Central Processing Unit (CPU), for example. The controller 14 may be an integrated circuit such as System-on-a-Chip (SoC) integrated with other components. The controller 14 may be composed of a combination of a plurality of integrated circuits. The controller 14 collectively controls the operation of the electronic device 1 to realize various functions.

In general, the transmission band in which the electronic device 10 transmits signals and the reception band in which the electronic device 10 receives signals are provided to each communication system such as LTE, WCDMA and GSM. Further, in many cases, a transmission band and a reception band of each communication system are adjacent to each other. A transmitting frequency band of the transmitting antenna 11 provided for a communication system is set so that it matches the transmission band of the communication system. Further, the receiving frequency band of the receiving antenna 12 provided for a communication system is set so that it matches the reception band of the communication system. However, the transmission band and the reception band are adjacent to each other, and thus the receiving antenna 12 may have a gain even in the transmission band. In this case, the communication characteristics of the transmitting antenna 11 may decrease due to interaction between the transmitting antenna 11 and the receiving antenna 12. Thus, in a specific case, the controller 14 shifts the receiving frequency band of the receiving antenna 12 to separate from the transmitting frequency band of the transmitting antenna 11. In this manner, interaction between the transmitting antenna 11 and the receiving antenna 12 is decreased and the communication quality can be improved.

In FIG. 1, an example in which the electronic device 10 includes one transmitting antenna 11 and one receiving antenna 12 is illustrated, but not limited thereto. As aforementioned, in recent years, the electronic device 10 is required to correspond also to MIMO that receives signals via a plurality of antennas. Here, the electronic device 10 includes a plurality of receiving antennas 12 each having at least the same receiving frequency band.

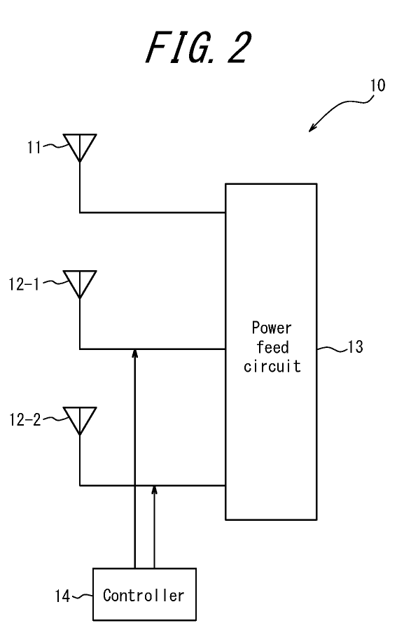

FIG. 2 illustrates a configuration example of the electronic device 10 that includes a plurality of receiving antennas 12 each having the same receiving frequency band. FIG. 2 illustrates an example of the electronic device 10 that includes two receiving antennas 12-1 and 12-2 each having the same receiving frequency band. The electronic device 10 may include three or more receiving antennas 12.

When the electronic device 10 includes a plurality of receiving antennas 12 each having the same receiving frequency band, the controller 14 shifts the receiving frequency band of at least one receiving antenna 12 of the receiving antennas 12 to separate from the transmitting frequency band of the transmitting antenna 11.

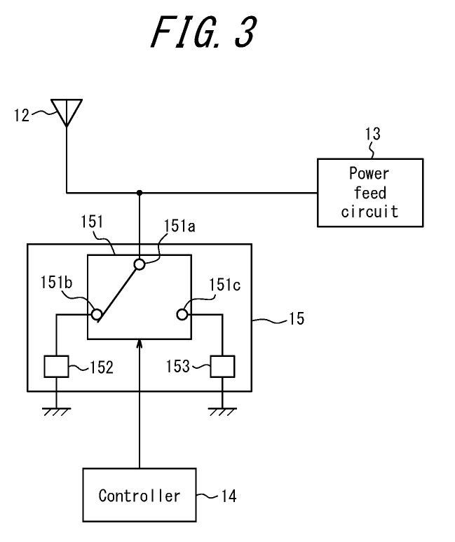

The receiving frequency band of the receiving antenna 12 is shifted in various configurations. FIG. 3 illustrates a configuration example for shifting the receiving frequency band of the receiving antenna 12.

In FIG. 3, a switching circuit 15 is connected to the connection point between the receiving antenna 12 and the power feed circuit 13. The switching circuit 15 includes a switch 151 and elements 152 and 153.

The switch 151 includes terminals 151a to 151c. The terminal 151a is connected to the connection point between the receiving antenna 12 and the power feed circuit 13. The terminal 151b is connected to one end of the element 152. The terminal 151c is connected to one end of the element 153. The switch 151 connects the terminal 151a to either the terminal 151b or the terminal 151c according to the control of the controller 14.

The elements 152 and 153 are composed of inductors and capacitors. One end of the element 152 is connected to the terminal 151b of the switch 151 and the other end thereof is grounded. One end of the element 153 is connected to the terminal 151c of the switch 151 and the other end is grounded. When the terminal 151a and the terminal 151b are connected, a resonance circuit that includes the receiving antenna 12 and the element 152 is formed. Further, when the terminal 151a and the terminal 151c are connected, a resonance circuit that includes the receiving antenna 12 and the element 153 is formed. Further, element values or the like of the elements 152 and 153 are set so that the resonance frequency of the resonance circuit that includes the receiving antenna 12 and the element 152 is different from the resonance frequency of the resonance circuit that includes the receiving antenna 12 and the element 153.

The receiving frequency band of the receiving antenna 12 is a specific frequency band centered on the resonance frequency of the resonance circuit that includes the receiving antenna 12. Therefore, for example, the element 152 is set so that the receiving frequency band of the receiving antenna 12 will be a resonance frequency that matches the reception band of the communication system to which the receiving antenna 12 corresponds. Further, the element 153 is set so that the receiving frequency band of the receiving antenna 12 will be a frequency band that is shifted to the direction separating from the transmitting frequency band of the transmitting antenna 11. Therefore, when the controller 14 controls the switch 151 (so that a terminal connected to the terminal 151a is switched from the terminal 151b to the terminal 151c), the receiving frequency band of the receiving antenna 12 can be shifted to separate from the transmitting frequency band of the transmitting antenna 11. Either element 152 or element 153 may be an open end.

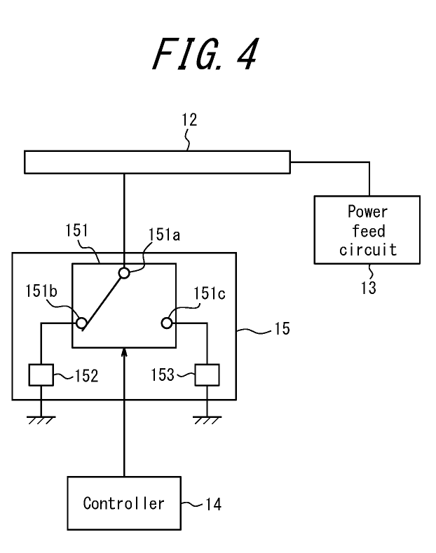

FIG. 4 illustrates another configuration example for shifting the receiving frequency band of the receiving antenna 12.

In FIG. 4, the switching circuit 15 is connected to a position apart from one end of the receiving antenna 12 (a power feed point of the power feed circuit 13) by a specific distance. Further, for example, the element 152 is set so that the receiving frequency band of the receiving antenna 12 will be a resonance frequency that matches the reception band of the communication system to which the receiving antenna 12 corresponds. Further, the element 153 is set so that the receiving frequency band of the receiving antenna 12 will be a frequency band that is shifted in a direction separating from the transmitting frequency band of the transmitting antenna 11. The receiving frequency band of the receiving antenna 12 can also be shifted to separate from the transmitting frequency band of the transmitting antenna 11 with this configuration by switching the terminal connected to the terminal 151a from the terminal 151b to the terminal 151c.

Next, operation of the electronic device 10 according to this embodiment is described. As illustrated in FIG. 2, hereinafter the electronic device 10 includes a plurality of receiving antennas 12 each having the same receiving frequency band and communicates using MIMO.

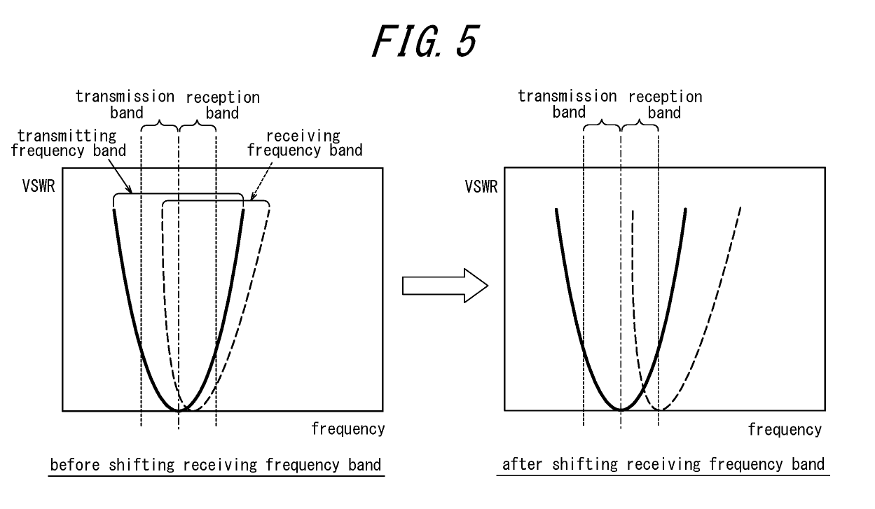

FIG. 5 illustrates frequency—voltage standing wave ratio (VSWR) characteristics of the transmitting antenna 11 and the receiving antenna 12. In FIG. 5, the horizontal axis indicates frequency and the vertical axis indicates VSWR. Further, the frequency—VSWR characteristics of the transmitting antenna 11 is indicated by a solid line and the frequency—VSWR characteristics of the receiving antenna 12 is indicated by a dashed line. Further, the transmitting frequency band and the receiving frequency band of the transmitting antenna 11 indicate a frequency band with VSWR equal to or less than a specific value.

As illustrated in FIG. 5, the transmission band and the reception band may be adjacent to each other. The transmitting frequency band of the transmitting antenna 11 is set so that it matches the transmission band, and the receiving frequency band of the receiving antenna 12 is set so that it matches the reception band. As aforementioned, the transmitting antenna 11 is used not only for transmitting signals but also for receiving signals. Thus the transmitting frequency band of the transmitting antenna 11 extends over the reception band.

When the electronic device 10 corresponds to MIMO, an downlink transmission rate (a transmission rate from the base station to the electronic device 10) is regarded as important, and in many cases, the electronic device 10 includes one transmitting antenna 11 (transmitting/receiving antenna) and a plurality of receiving antennas 12. In general, a possibility of communication failure due to lack of radio wave intensity in the uplink direction from the electronic device 10 to the base station is higher than a possibility of communication failure due to lack of radio wave intensity in the downlink direction. Further, as aforementioned, in many cases, one transmitting antenna 11 is provided. Thus when the characteristics of the transmitting antenna 11 are degraded due to interaction between the antennas, a larger influence is given on the communication quality compared with the case where the characteristics of the receiving antenna 12 are degraded. In this case, when a plurality of antennas resonate at the same or close resonance frequency, the interaction between antennas is increased.

Thus, in this embodiment, when the uplink communication characteristics are degraded, the controller 14 changes a resonance frequency of at least one receiving antenna 12 of receiving antennas 12, and shifts the receiving frequency band of the receiving antenna 12 to separate from the transmitting frequency band of the transmitting antenna 11, as illustrated in FIG. 5. When the receiving frequency band of the receiving antenna 12 is shifted to separate from the transmitting frequency band of the transmitting antenna 11, the interaction between the receiving antenna 12 and the transmitting antenna 11 is mitigated, and degradation of the uplink communication characteristics can be suppressed.

In general, in the region where the downlink radio wave intensity is weak such as an edge of communication area of the base station, it is known that the uplink radio wave intensity also weakens. In such an environment where the uplink radio wave intensity is weak, degradation of the uplink communication characteristics is likely to occur. Thus, in this embodiment, when the uplink communication characteristics are degraded, the receiving frequency band of the receiving antenna 12 is shifted to separate from the transmitting frequency band of the transmitting antenna 11 to suppress degradation of the uplink communication characteristics. The uplink communication is enabled also in the edge of the communication area of the base station by suppressing degradation of the uplink communication characteristics, and the communication stability can be improved. Although the receiving sensitivity in MIMO communication is decreased by shifting the receiving frequency band of the receiving antenna 12, a plurality of receiving antennas 12 are provided, and thus a certain degree of receiving characteristics can be ensured even if the receiving frequency band of some of the receiving antennas 12 are shifted.

As aforementioned, in general, the possibility of communication failure due to lack of the uplink radio wave intensity from the electronic device 10 to the base station is higher than the possibility of communication failure due to lack of the downlink radio wave intensity. Therefore, as illustrated in FIG. 1, even if the electronic device 10 includes one transmitting antenna 11 and one receiving antenna 12, when the uplink communication characteristics is degraded, the possibility of communication failure due to lack of uplink radio wave intensity is reduced by shifting the receiving frequency band of the receiving antenna 12 to separate from the transmitting frequency band of the transmitting antenna 11, and thus the communication quality can be further improved.

The controller 14 can detect degradation of the uplink communication characteristics on the basis of signals transmitted from the base station. In general, when the electronic device 10 gives no response to a signal transmitted from the base station, a signal indicating that no response is given to the signal transmitted from the base station is transmitted from the base station to the electronic device 10. Further, when the signal intensity from the electronic device 10 is insufficient, a signal instructing to increase the transmission power is transmitted from the base station to the electronic device 10. When a signal indicating that no response is given is transmitted from the base station despite the fact that the electronic device 10 receives a signal from the base station and transmits a response to the signal, it is assumed that the uplink communication characteristics are degraded. Further, when an instruction to increase the transmission power is given from the base station, it is also assumed that the uplink communication characteristics are degraded. Therefore, the controller 14 detects degradation of the uplink communication characteristics on the basis of a signal indicating a degradation of the receiving quality of a signal from the electronic device 10 transmitted from the base station.

Further, when the electronic device 10 includes a plurality of receiving antennas 12, the controller 14 may shift the receiving frequency band of at least one receiving antenna, which has a higher correlation (a larger influence) with the transmitting antenna 11, of the receiving antennas 12.

Further, when the electronic device 10 includes a plurality of receiving antennas 12, the controller 14 may shift receiving frequency bands of respective receiving antennas 12 in order of correlation with the transmitting antenna 11, from the highest to the lowest. Further, when the communication characteristics necessary for the uplink communication is ensured, the controller 14 ends the processing of shifting the receiving frequency band of the receiving antenna 12. In this case, for example, when receiving a signal instructing to maintain or decrease the transmission power from the base station, the controller 14 determines that the communication characteristics necessary for the uplink communication is ensured.

The receiving antenna 12 highly correlated with the transmitting antenna 11 can be specified on the basis of arrangement of the transmitting antenna 11 and the receiving antenna 12, for example. Further, the receiving antenna 12 highly correlated with the transmitting antenna 11 can be an antenna having the same polarization plane as the transmitting antenna 11, for example.

Further, when the electronic device 10 includes a plurality of receiving antennas 12, the controller 14 shifts receiving frequency bands of respective receiving antennas 12 sequentially, and may determine a receiving antenna 12 highly correlated with the transmitting antenna 11 according to the communication characteristics of the transmitting antenna 11 with receiving frequency bands of respective receiving antennas 12 shifted.

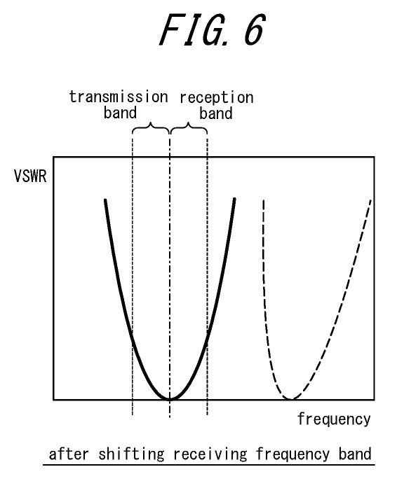

Further, as for the receiving antenna 12 particularly highly related to the transmitting antenna 11 for a structural reason or the like, the controller 14 may shift the receiving frequency band to completely separate from the transmitting frequency band of the transmitting antenna 11 as illustrated in FIG. 6.

As aforementioned, in this embodiment, the electronic device 10 includes the transmitting antenna 11, the receiving antenna 12 and the controller 14 configured to shift the receiving frequency band of the receiving antenna 12 to separate from the transmitting frequency band of the transmitting antenna 11.

The interaction between the receiving antenna 12 and the transmitting antenna 11 is reduced by shifting the receiving frequency band of the receiving antenna 12 to separate from the transmitting frequency band of the transmitting antenna 11. Thus the communication quality can be further improved.

Although an embodiment of this disclosure has been described on the basis of various drawings and examples, it is to be noted that a variety of modifications and changes are easily made by a person skilled in the art on the basis of this disclosure. Accordingly, it is to be understood that such modifications and changes are included in the scope of this disclosure.

### REFERENCE SIGNS LIST

10 Electronic device

11 Transmitting antenna

12, 12-1, 12-2 Receiving antenna

13 Power feed circuit

14 Controller

15 Switching circuit

151 Switch

151a, 151b, 151c Terminal

152, 153 Element

1. An electronic device comprising:
a transmitting antenna;
a receiving antenna; and
a controller configured to shift a receiving frequency band of the receiving antenna to separate from a transmitting frequency band of the transmitting antenna.

2. The electronic device according to claim 1 comprising:
a plurality of receiving antennas each having at least a same receiving frequency band, wherein the controller shifts a receiving frequency band of at least one receiving antenna of the receiving antennas.

3. The electronic device according to claim 2, wherein the controller shifts a receiving frequency band of the receiving antennas in order of correlation with the transmitting antenna, from a highest to a lowest.

4. The electronic device according to claim 2, wherein the controller shifts receiving frequency bands of respective receiving antennas, determines an antenna highly correlated with the transmitting antenna according to communication characteristics of the transmitting antenna with the receiving frequency bands of respective receiving antennas shifted, and shifts each of the receiving frequency bands in order of correlation with the transmitting antenna, from a highest to a lowest.

5. The electronic device according to claim 1, wherein when receiving a signal from a communication device communicated wirelessly with the electronic device, the signal indicating degradation of receiving quality of a signal from the electronic device, the controller shifts the receiving frequency band of the receiving antenna.

6. The electronic device according to claim 1, wherein the controller shifts the receiving frequency band of the receiving antenna to completely separate from the transmitting frequency band of the transmitting antenna.
